(19) United States
(12) Patent Application Publication
(10) Pub. No.: US 2013/0149685 A1
(43) Pub. Date: Jun. 13, 2013

(54) CHEMICAL MODELING KIT

(71) Applicant: Bettina HEINZ, Escondido, CA (US)

(72) Inventor: Bettina HEINZ, Escondido, CA (US)

(21) Appl. No.: 13/709,925

(22) Filed: Dec. 10, 2012

Related U.S. Application Data
(60) Provisional application No. 61/569,356, filed on Dec. 12, 2011.

(51) Int. Cl. G09B 23/26

(52) U.S. Cl. CPC G09B 23/26
USPC 434/298

(57) ABSTRACT

A simple chemical modeling kit meets these needs and can be used by chemistry students, especially beginning students, to understand spatial relationships of atoms within molecules and to comprehend the shapes of molecules. The kit can comprise a plurality of rigid rods of the same length, width, and thickness, which can be manipulated to illustrate chemical structures. The structural formulas produced by the use of the kit can be described as abbreviated structural formulas.

### CROSS-REFERENCES

This application claims the benefit of U.S. Provisional Patent Application Ser. No. 61/569,356 by Dr. Bettina Heinz, entitled “Chemical Modeling Kit” and filed on Dec. 12, 2011, the contents of which are hereby incorporated in their entirety by this reference.

### FIELD OF THE INVENTION

The present invention is directed to chemical modeling kits suitable for use by chemistry students and methods for their use.

### BACKGROUND OF THE INVENTION

One of the most important aspects of chemistry, especially organic chemistry, is the spatial relationship of atoms within molecules held together by covalent bonds. Because covalent bonds have defined bond lengths and bond angles, organic molecules have defined shapes that are determined by these bond lengths and bond angles. The bond lengths and bond angles vary with the particular atoms involved in the bonds (carbon, hydrogen, oxygen, nitrogen, phosphorus, sulfur, and halogens), and with the type of bonding involved (single, double, or triple bonds).

Therefore, it is important for students to understand the spatial relationships of atoms within molecules held together by covalent bonds and the resulting shapes of the molecules. One of the tools that students can use to understand these concepts is molecular models.

Although many molecular modeling kits are available, in many cases, these are expensive, difficult to use, or both. There is a continuing need for a simple, inexpensive, and easy-to-use molecular modeling kit that is particularly suitable for use by students, especially beginning students.

### SUMMARY OF THE INVENTION

A simple chemical modeling kit meets these needs and can be used by chemistry students, especially beginning students, to understand spatial relationships of atoms within molecules and to comprehend the shapes of molecules. The formulas produced by use of the kit can be described as abbreviated structural formulas.

One aspect of the present invention is a chemical modeling kit comprising a plurality of rigid rods of the same length, width, and thickness, which can be manipulated to illustrate chemical structures. Typically, the rods are about 5.0 to about 6.0 cm in length. More typically, the rods are about 5.5 cm in length. Typically, the rods are about 0.50 cm to about 0.60 cm in width. More typically, the rods are about 0.55 cm in width. Typically, the rods have rounded ends.

Typically, the rods are constructed of a material selected from the group consisting of wood, metal, and plastic. More typically, the rods are constructed of wood.

Typically, the rods are of a color selected from the group consisting of black, blue, gray, red, and green. More typically, the rods are black.

In another alternative, the rods are of two or more colors, with each rod being of a single color, so that rods of multiple colors are included in the kit. In yet another alternative, wherein at least one of the rods is colored in such a manner that one-half of the rod is one color and the other half another color.

Typically, the rods are about 0.20 cm thick.

Typically, the kit comprises from 15 rods to 30 rods. More typically, the kit comprises 25 rods.

The kit can further comprise instructions, separately packaged.

### BRIEF DESCRIPTION OF THE DRAWINGS

These and other features, aspects, and advantages of the present invention will become better understood with reference to the following description, appended claims, and accompanying drawings where:

FIG. 1 shows the structures of ethane and propane as depicted by the rods of the chemical modeling kit of the present invention.

FIG. 2 shows the use of the rods to depict multiple bonds.

FIG. 3 shows the use of the rods to depict conformational isomers.

FIG. 4 shows the use of the rods to depict configurational isomers.

FIG. 5 shows the use of the rods to illustrate multiple bond arrangements such as isolated, conjugated, or cumulated bonds.

FIG. 6 shows the use of the rods to illustrate constitutional isomers.

FIG. 7 shows the use of the rods to simulate a tetrahedral bond arrangement.

FIG. 8 shows the use of the rods to show resonance structures such as the Kekule structures for benzene.

FIG. 9 shows the use of the rods to depict benzenoid, dienoid, and quinoid structural elements within unsaturated ring systems.

FIG. 10 shows the use of the rods to depict the course of the DielsAlder cycloaddition reaction.

FIG. 11 shows the conversion of structural formulas depicted by the use of the rods of the present invention into other formula types, such as expanded structural formulas, molecular formulas, and condensed structural formulas.

### DETAILED DESCRIPTION OF THE INVENTION

One aspect of the present invention is a molecular modeling kit. The formulas produced by use of the kit can be described as abbreviated structural formulas.

Line-angle structural formulas are very common in organic chemistry. They are also known as abbreviated or skeletal structures. The bond lines and angles are represented by a straight line, usually in black. Every corner or connecting joint and end group of these lines represents a carbon atom. The hydrogen atoms and bonds are not written but assumed.

When working with structural formulas one must keep in mind that neutral carbon atoms always connect to other atoms via four bonds, either four single bonds, a double bond and two single bonds, a triple bond and a single bond, or two double bonds. Regardless of what bond order is involved, all bonds or lines must add up to four including the assumed ones to the hydrogen atoms. Hydrogen is always single-bonded.

With these rules in mind one can substitute the lines written on paper with the rods, such as black wooden rods, of a model kit according to the present invention. The benefit of working with the model kit is the flexibility of the models. By moving bonds around on the chosen platform, such as white poster board or foam mats, the structures can be changed and realigned instantly. Thus, the model kit can illustrate effectively the concepts of the different types of isomerism, the practice of naming compounds according to IUPAC rules, and visualize the steps of certain reaction mechanisms such as cycloaddition (Diels-Alder), 1,2- and 1,4-addition, poly-addition, and other reaction mechanisms.

Resonance contributors can be easily conceptualized, the Kekule structures of benzene better understood, and benzenoid and dienoid systems differentiated.

By working with this hands-on model kit the brain incorporates the subject matter to be learned more readily and effectively. It has been found that computer-based learning, although very informative, does not produce the same degree of long-term cognitive recognition.

The kit is also available for organic compounds involving heteroatoms such as oxygen, nitrogen, sulfur, phosphorus, fluorine, chlorine, bromine, iodine, or other heteroatoms.

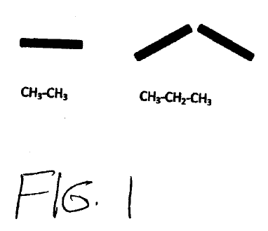

Typically, the kit contains 25 black rods (0.6×5.5 cm), although the kit can include a larger or smaller number of rods. A free end represents one carbon atom and any joints of two to four rods represent one carbon atom as well. Remember that any links to necessary hydrogen atoms are not shown but must be assumed in order to satisfy the four-bond capacity of carbon. This is shown in FIG. 1 with the structures of ethane (CH₃—CH₃) and propane (CH₃—CH₂—CH₃).

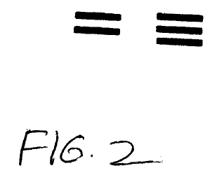

Multiple bonds are indicated by two or three parallel rods, as shown in FIG. 2.

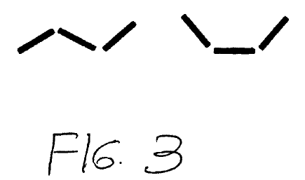

Conformational isomers can be shown by free rotation of the rods. Only single bonds are able to rotate freely about the bond axis. These types of isomeric structures differ slightly in energy values depending on the degree of steric repulsion or hindrance (maximum distance between the atomic groups is preferred and most stable) and are also referred to as rotamers. Conformational isomers are shown in FIG. 3.

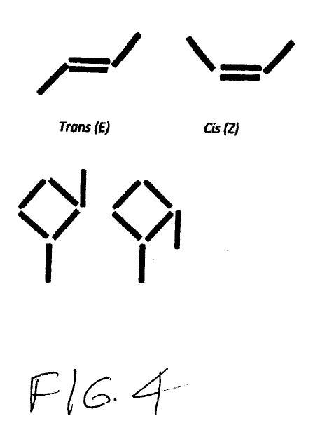

Configurational isomers require a rotational barrier such as double bonds or ring structures. Cis-trans or E-Z structures can be differentiated as shown in FIG. 4. The energy barrier between both forms is higher than for rotational isomers but lower than for structural (constitutional) isomers).

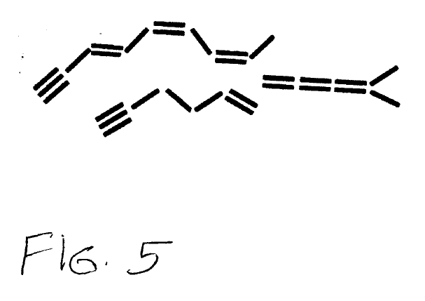

Multiple bond arrangements (isolated, conjugated, and cumulated—the latter only involved with double bonds) can be represented and resonance structures interrelated, as is shown in FIG. 5.

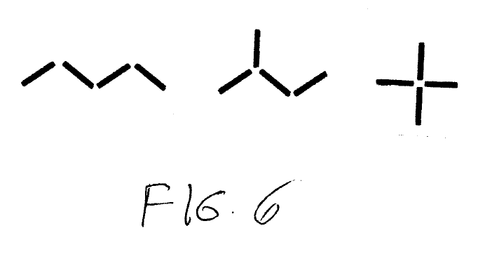

Constitutional isomers are interchanged by reconnecting the rods into different patterns. FIG. 6 shows n-pentane, 2-methylpropane (isopentane), and neopentane.

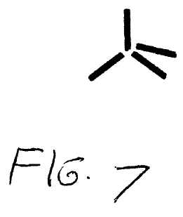

Three-dimensional structures cannot be directly shown with this model since no dash-wedge type of bond symbolism can be represented. Therefore, one can simulate a tetrahedral type of bond situation as shown in FIG. 7 or just show a cross-like structure.

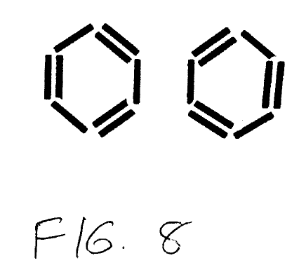

Resonance structures known as Kekule structures for benzene and the many more possible varieties for higher arenes and condensed ring systems can be easily shown by rotating the rods around the ring as shown in FIG. 8. FIG. 8 shows the classic example of benzene, represented by two structures with alternating single and double bonds; the actual benzene molecule is a composite such that the bonds between each of the six carbons are neither single bonds nor double bonds, but of intermediate character; each of the bonds is in fact equivalent. Resonance can be illustrated by moving the rods representing double bonds to alternative position to illustrate each of two or more resonance structures.

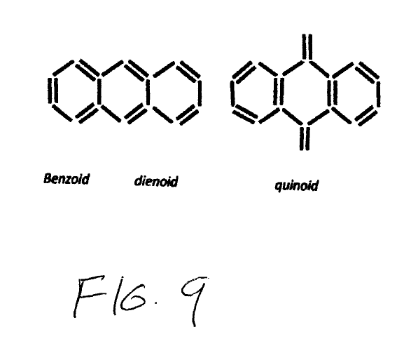

Benzenoid, dienoid, and quinoid structural elements within unsaturated ring systems can be recognized and interchanged by bond rotation as well as shown in FIG. 9.

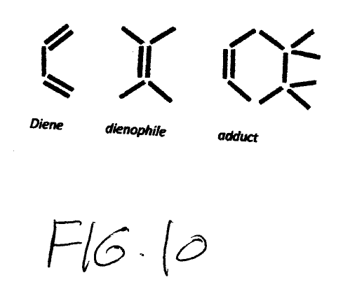

Certain reaction mechanisms that require some “mental acrobatics” can be followed through and exercised by moving the bonds in the required pericyclic fashion. Cycloaddition (Diels-Alder), its retro form, 1,2-addition, 1,4-addition, as well as poly-addition can be more readily visualized and better understood. FIG. 10 shows the Diels-Alder addition reaction, with the diene, the dienophile, and the resulting adduct.

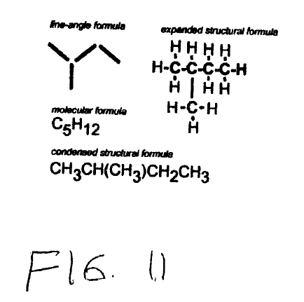

Conversion of the bond-angle structures into other formula types, such as expanded structural formulas, molecular formulas, and condensed structural formulas can be readily performed, as shown in FIG. 11.

The model kit also allows the practice and the development of expertise in naming organic compounds according to the IUPAC rules. Students can exercise this process together—one showing a certain structure and others finding the proper name. The model is large enough for more individuals to take part allowing for effective group learning.

An instructor can place the rods on an overhead projector and move the rods about to form a variety of structures and call for active participation of the students. The process is thoroughly enjoyed by the students making them rationalize more or less complex concepts in shorter time periods and much more efficiently.

The molecular modeling kit comprises a plurality of rigid rods made out of any suitable material. Each of the rigid rods is of the same length, width and thickness. Typically, the rods are from about 5.0 to about 6.0 cm in length. Preferably, the rods are about 5.5 cm in length. Typically, the rods have a width of from about 0.55 cm to about 0.65 cm. Preferably, the rods are about 0.60 cm in width. Typically, the rods have rounded ends.

The rods can be made out of any suitable material, such as metal, wood, or plastic. All the rods in the kit are made out of the same material. The rods can be any suitable color; in one alternative, all the rods in the kit are the same color. In one alternative, the rods are black, which gives a high degree of contrast when the rods are arranged on a white surface such as a sheet of paper; other colors such as blue, gray, red, or green can be used. However, other colors can be used. It is also possible to use rods of different colors or, in larger kits, rods in which one-half of the rod is one color and the other half of the rod is another color; this may be useful in constructing molecules in which heteroatoms such as nitrogen, oxygen, or sulfur are included.

The rods can be of any convenient thickness; typically, the rods are about 0.20 cm thick.

The number of rods in the kit can vary; typically, there are from 15 rods to 30 rods in the kit, although the kit can include a greater number of rods; even 50 or 100 rods can be included in a single kit if desired. In one preferred alternative, the kit includes 25 rods. The number of rods in the kit needs to be sufficient to construct chemical structures of reasonable complexity as described below; these structures can include double bonds, triple bonds, or aromatic structures such as benzene rings.

The rods of the kit can be placed and manipulated to show chemical structures, including their shapes and bonding. Double and triple bonds can be represented by placing the rods alongside each other as described above.

Typically, in the use of the rods, where only single bonding is involved, the end of each rod represents a single atom involved in covalent bonding, such as normally occurs in organic molecules. Thus, for a saturated (aliphatic) 6-carbon ring, namely cyclohexane, six rods are used. For a three-carbon saturated (aliphatic) hydrocarbon, namely propane, three rods are used. The rods can be arranged to illustrate appropriate bond angles, such as 109° for tetrahedral bonding or 60° in benzene or cyclohexane as described above. Examples of the use of the rods are shown in FIGS. 1-11 above.

Typically, a molecular modeling kit according to the present invention further comprises instructions, separately packaged. These instructions are typically printed on one or more sheets of paper included in the kit. The instructions can, for example, be keyed to a chemistry textbook so that students can use the kit to construct and work with appropriate chemical structures as directed by the textbook so that they gain a better grasp of the concepts presented in that section of the textbook.

Therefore, one aspect of the present invention is a chemical modeling kit comprising a plurality of rigid rods of the same length, width, and thickness, which can be manipulated to illustrate chemical structures. Typically, the rods are from about 5.0 to about 6.0 cm in length. Preferably, the rods are about 5.5 cm in length. Typically, the rods have a width of from about 0.55 cm to about 0.65 cm. Preferably, the rods are about 0.60 cm in width. Typically, the rods have rounded ends.

Typically, the rods are constructed of wood; however, the rods can alternatively be constructed of plastic, metal, or another rigid material. The rods can be any suitable color, such as black, blue, gray, red, or green. In one preferred alternative, the rods are black.

In yet another alternative, the rods are of two or more colors, each rod being of a single color, so that rods of multiple colors are included in a single kit. In yet another alternative, some of the rods are colored in such a manner that one-half of the rod is one color and the other half another color.

The rods can be of any convenient thickness; typically, the rods are about 0.20 cm thick.

Typically, there are from 15 rods to 30 rods in the kit, although the kit can include a greater number of rods; even 50 or 100 rods can be included in a single kit if desired. In one preferred alternative, the kit includes 25 rods.

Typically, a kit further includes instructions, separately packaged.

### ADVANTAGES OF THE INVENTION

The present invention provides a useful and inexpensive way for a student studying chemistry, especially organic chemistry, to study and understand chemical bonding, structures of organic molecules, resonance, and isomerism. The kits of the present invention can also be used alongside more complex models to convey the basic structural information involved in organic molecules. The formulas produced by use of the kit can be described as abbreviated structural formulas.

The present invention possesses industrial applicability as an article of manufacture suitable for the teaching of chemistry.

With respect to ranges of values, the invention encompasses each intervening value between the upper and lower limits of the range to at least a tenth of the lower limit's unit, unless the context clearly indicates otherwise. Moreover, the invention encompasses any other stated intervening values and ranges including either or both of the upper and lower limits of the range, unless specifically excluded from the stated range.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed.

All the publications cited are incorporated herein by reference in their entireties, including all published patents, patent applications, and literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A chemical modeling kit comprising a plurality of rigid rods of the same length, width, and thickness, which can be manipulated to illustrate chemical structures.

2. The chemical modeling kit of claim 1 wherein the rods are about 5.0 to about 6.0 cm in length.

3. The chemical modeling kit of claim 2 wherein the rods are about 5.5 cm in length.

4. The chemical modeling kit of claim 1 wherein the rods are about 0.50 cm to about 0.60 cm in width.

5. The chemical modeling kit of claim 4 wherein the rods are about 0.55 cm in width.

6. The chemical modeling kit of claim 1 the rods have rounded ends.

7. The chemical modeling kit of claim 1 wherein the rods are constructed of a material selected from the group consisting of wood, metal, and plastic.

8. The chemical modeling kit of claim 7 wherein the rods are constructed of wood.

9. The chemical modeling kit of claim 1 wherein the rods are of a color selected from the group consisting of black, blue, gray, red, and green.

10. The chemical modeling kit of claim 9 wherein the rods are black in color.

11. The chemical modeling kit of claim 1 wherein the rods are of two or more colors, with each rod being of a single color, so that rods of multiple colors are included in the kit.

12. The chemical modeling kit of claim 1 wherein at least one of the rods is colored in such a manner that one-half of the rod is one color and the other half another color.

13. The chemical modeling kit of claim 1 wherein the rods are about 0.20 cm thick.

14. The chemical modeling kit of claim 1 wherein the kit comprises from 15 rods to 30 rods.

15. The chemical modeling kit of claim 14 wherein the kit comprises 25 rods.

16. The chemical modeling kit of claim 1 wherein the kit further comprises instructions, separately packaged.
